(19) United States
(12) Patent Application Publication
(10) Pub. No.: US 2024/0143943 A1
(43) Pub. Date: May 2, 2024

(54) STRING SIZING NETWORK SERVICE

(71) Applicant: Ford Global Technologies, LLC, Dearborn, MI (US)

(72) Inventors: Saul Moreno, pb09 Mexico cdmx (MX); Aaron Lara, Tultitlan/Mexico (MX)

(73) Assignee: Ford Global Technologies, LLC, Dearborn, MI (US)

(21) Appl. No.: 18/050,191

(22) Filed: Oct. 27, 2022

(51) Int. Cl. G06F 40/42

(52) U.S. Cl. CPC G06F 40/42

(57) ABSTRACT

A system for distributing string length computation by a server computer coupled to a computer network. A server memory stores executable server instructions to receive a client request over the computer network at a server network endpoint, determine a pixel size of display text based on the string specification, and transmit a server response over the computer network. The client request includes a string specification with a display text, a font identifier, a font size, and a display resolution. The server response includes the pixel size of the display text.

### BACKGROUND

Vehicles are often equipped with displays to provide text messages to vehicle occupants. Different vehicle models can have different displays with different display sizes and resolutions. In addition, the text messages shown on displays may be in various languages, fonts, and sizes. The management of the different displays and the various messages to be displayed on a human-machine interface (HMI) could be enhanced.

### BRIEF DESCRIPTION OF THE DRAWINGS

FIG. 1 shows an example string sizing network system.

FIG. 2 shows an example client application executing at the client.

FIG. 3 shows an example string specification encoded in JSON and enclosed in a body of a HTTP POST request method.

FIG. 4 shows an example server response from a server to the client.

FIG. 5 shows an example method for distributed string length computation.

FIG. 6 shows an implementation of a determining operation

FIG. 7 shows example method operations performed by a client.

### DETAILED DESCRIPTION

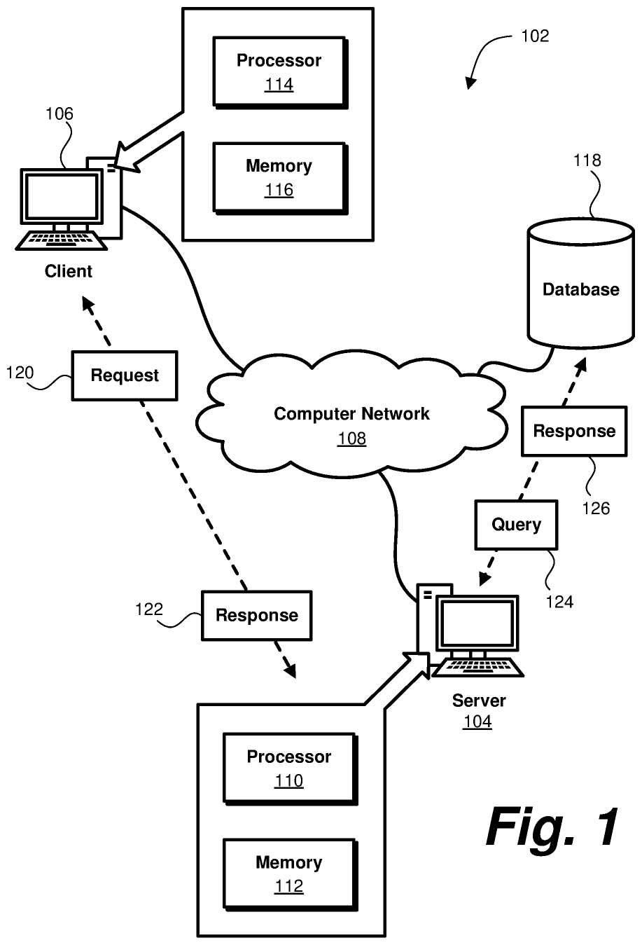

Throughout the description reference is made to FIGS. 1-7. When referring to the figures, like structures and elements shown throughout are indicated with like reference numerals.

Described herein are methods and systems for distributed text length computation. Implementations herein efficiently determine the size of text, i.e., the pixel width of text to be displayed, of various fonts, font sizes, and languages for a constrained display area. Text sizing can be achieved with reduced time and increased computational and network efficiency.

Accordingly, included in the present disclosure is a system for distributing string length computation. The system is made up of a server computer processor and a server memory. The server computer processor is coupled to a computer network and the server memory stores server instructions executable by the server computer processor. The instructions direct the server computer processor to receive a client request over the computer network at a server network endpoint. The client request includes a string specification with a display text, a font identifier, a font size, and a display resolution. The instructions further direct the server computer processor to determine a pixel size of the display text based on the string specification, and transmit a server response over the computer network, the server response including the pixel size of the display text.

The string specification includes the available display area and the server instructions may further determine whether the pixel size exceeds an available display area at a vehicle display. The server response may include an overflow indication when the pixel size exceeds the available display area at the vehicle display.

The server instructions may include instructions to query a library configured to return the pixel size of the display text, and to receive the pixel size of the display text from the library. The server instructions may further include instructions to authenticate a client that transmitted the client request, and to determine that the client is authorized to use services of the server computer processor.

In one configuration, the server instructions may include instructions to translate the display text into a plurality of translated texts, with each of the translated texts having a different language than the display text. The server instructions can determine the pixel size of each of the plurality of translated texts based on the string specification. The server response includes the pixel size of each of the translated texts.

The system may include a client computer processor coupled to the computer network and a client memory. The client memory stores client instructions executable by the client computer processor to send the client request over the computer network from an application executing at the client. The application includes a first cell displaying the display text and a second cell configured to display the pixel size transmitted by the server computer processor.

The client instructions may include instructions to translate the display text into a plurality of translated texts. Each of the translated texts has a different language than the display text, and the text specification includes the translated texts. Furthermore, the server instructions may include instructions to determine the pixel size of each of the translated texts based on the string specification. The server response includes the pixel size of each of the translated texts.

The present disclosure also details a method for distributed string length computation. The method includes receiving, by a server, a client request over a computer network at a network endpoint. The client request includes a string specification with one or more of a display text, a font identifier, a font size, and a display resolution. A determining step determines, by the server, a pixel size of the display text based on the string specification. A transmitting step transmits, by the server, a server response over the computer network. The server response includes the pixel size of the display text.

The string specification may include the available display area, and the method may include a determining step to determine whether the pixel size exceeds the available display area at a vehicle display. The server response may include an overflow indication when the pixel size exceeds the available display area at the vehicle display. In one configuration, an invoking step invokes a library configured to return the pixel size of the display text, and a receiving step receives the pixel size of the display text from the library.

In one arrangement, an authenticating step authenticates, by the server, a client that originated the client request. The method may include a determining step to determine, by the server, if the client is authorized to use services of the server. A translating step translates, by the server, the display text into a plurality of translated texts. Each of the plurality of translated texts is in a different language than the display text. A determining step determines, by the server, the pixel size of each of the translated texts based on the string specification. The server response includes the pixel size of each of the translated texts.

The method may include sending, by a client, the client request over the computer network from an application executing at the client. The application includes a first cell displaying the display text and a second cell configured to display the pixel size transmitted by the server. A translating step translates, by the client, the display text into a plurality of translated texts, with each of the translated texts being a different language than the display text. The text specification may include the translated texts and a determining step determines, by the server, the pixel size of each of the translated texts based on the string specification. The server response includes the pixel size of each of the plurality of translated texts.

The present disclosure also details a computer program product for distributing string length computation. The computer program product includes a non-transitory computer readable storage medium having computer readable program code embodied therewith. The computer readable program code is configured to receive a client request including a string specification over a computer network at a network endpoint, determine a pixel size of the display text based on the string specification, and transmit a server response over the computer network, the server response including the pixel size of the display text. The string specification include one or more of a display text, a font identifier, a font size, and a display resolution.

The computer readable program code may be further configured to determine whether the pixel size exceeds an available display area at a vehicle display. The string specification may include the available display area, and the server response may include an overflow indication when the pixel size exceeds the available display area at the vehicle display. The computer readable program code may be further configured to query a library configured to return the pixel size of the display text and receive the pixel size of the display text from the library.

FIG. 1 shows an example string sizing network system 102. The system 102 can facilitate design of an HMI with display text, i.e., one or more characters such as ASCII characters, that fits a display, e.g., a designated area of a display. The system 102 includes a server 104 and a client 106 coupled to a computer network 108.

The computer network 108 can include a local area network (LAN), an intranet, a virtual private network (VPN), metropolitan area network (MAN), wireless local area network (WLAN), and/or a wide area network (WAN), such as the internet. The computer network 108 may further include various hardware for facilitating communications, such as modems, routers, switches, hubs, network interface cards (NICs), and cables. The network may comprise copper transmission cables, routers, firewalls, switches, gateway computers and/or edge servers. The computer network 108 may use various communication protocols, such as include IP (Internet Protocol, including IPv4 and IPv6), TCP (Transmission Control Protocol), UDP (User Datagram Protocol), SCTP (Stream Control Transmission Protocol), RTP, RTCP (RTP Control Protocol), RSTP, IP Multicast, HTTP (Hypertext Transfer Protocol) and the secure variant HTTPS, and many other current and future protocols, and may use baseband or broadband signaling.

The server 104 is a computer configured to provide services to the client 106. In one implementation, the server 104 is configured to provide an application program interface (API) using existing HTTP methodologies, such as REST or SOAP. The server 104 may be a remote server and may perform information processing, searching, e-commerce, or other transactions or support services remote from the client 106. The server 104 includes a server computer processor 110 and a server memory 112.

The server computer processor 110 can be a general purpose computer, special purpose computer, or other programmable data processing apparatus to produce a machine. The server memory 112 can include various volatile and non-volatile technologies, such as a hard disk, random access memory (RAM), read-only memory (ROM) and flash memory.

The client 106 can be any end-user computer of the system 102. The client 106 includes a server computer processor 110 and a client memory 116. Similar to the server components, the client computer processor 114 can be a general purpose computer, special purpose computer, or other programmable data processing apparatus to produce a machine. The client memory 116 can include various volatile and non-volatile technologies, such as a hard disk, RAM, ROM, and flash memory.

The system 102 may include a database 118 coupled to the computer network 108. The term “database” is used broadly herein to mean a system for storing and retrieving a grouping of data values typically stored in a computer memory and organized for convenient access. The database may be relational, hierarchical, NoSQL, or other type of database known in the art. It is contemplated that the database may be hosted at the server 104, the client 106, or a separate database server.

In one implementation, the server memory 112 stores server instructions executable by the server computer processor 110. The server instructions include instructions to receive a client request 120 over the computer network at a server network endpoint.

In one implementation, the client request 120 is POST request to a URL with a string specification payload formatted in JavaScript Object Notation (JSON). Other request formats, such as GET requests and an Extensible Markup Language (XML) data schema, may be used by the system 102. The client request 120 includes a string specification with a display text, a font identifier, a font size, and a display resolution.

Upon receiving the client request 120, the server 104 may authenticate the client 106 and determine that the client 106 is authorized to use services of the server computer processor. If the client 106 cannot be authenticated or is not authorized to user the services, the server 104 may send an “unauthorized” or “forbidden” status code, such as HTTP 401 or 403, to the client 106.

If the client is authenticated and is authorized to use the server 104, the server 104 executes instructions to determine a pixel size of the display text based on the string specification in the client request 120. In one implementation, determining the display text's pixel size includes instructions to invoke a library stored in the server memory 112. The server 104 can, for example, create a command string for the library based on the parsed client request 120 and a font (and/or font directory) name.

Once the command string is assembled, the library is invoked to return the pixel size of the display text. In one implementation, the library stores in server memory 112 a graphical representation of the display text based on the command string. The library may be a static library, a dynamic link library (DLL), or a shared object (SO) called or invoked by the server 104.

The instructions are further configured to receive the pixel size of the display text from the library and to transmit a server response 122 with the pixel size of the display text to the client 106 over the computer network 108. The response 122 may indicate the request was successfully completed with, for example, an HTTP 200 status code.

In one implementation, the client request 120 includes specification of an available display area at a vehicle display. The server instructions are further configured to determine whether the pixel size exceeds the available display area at the vehicle display. If the pixel size does exceed the available display area at the vehicle display, the server response 122 can include an overflow indication.

In a further implementation, the server memory 112 may include instructions to translate the display text into a plurality of translated texts, with each of the translated texts being a different language (e.g., English, Spanish, etc.) than the display text. Once the translated texts are generated, the server 104 executes instructions to determine a pixel size of each of the translated texts based on the string specification. As discussed above, the pixel size may be determined by an external library configured to return the pixel size of the display text. In addition, the server response 122 includes the pixel size of each of the translated texts.

The client memory 116 stores instructions executable by the client computer processor 114. These instructions can include instructions to send the client request 120 over the computer network 108 from an application executing at the client 106. In one implementation, the application is spreadsheet application, such as Microsoft® Excel, that includes a first cell displaying the display text and a second cell configured to display the pixel size transmitted by the server.

In one implementation, the client instructions include instructions to translate the display text into a plurality of translated texts. Each of the translated texts can be in a different language than the display text. The translated texts are included in the client request 120 and the server response 122 includes the pixel size of each of the translated texts.

In another implementation, the server memory 112 includes instructions to issue a database query 124 by the server 104 to the database 118 for a target font specified in the client request 120. The database query 124 may be formatted in a structured query language (SQL). The database 118 sends a database response 126 containing a listing of all the font names, font locations, and font versions of the target font. The database query 124 and database response 126 may be handled by any suitable database management system (DBMS).

When a font version in the database response 126 matches a font version specified in the client request 120, the server instructions may further cause the server 104 to select a font location associated with the font version in the database response 126. Alternatively, when there is no font version match, the server 104 may be instructed to select the font version and font location of the latest font version listed in the database response 126. The selected font location is then used to perform the font size calculations discussed above.

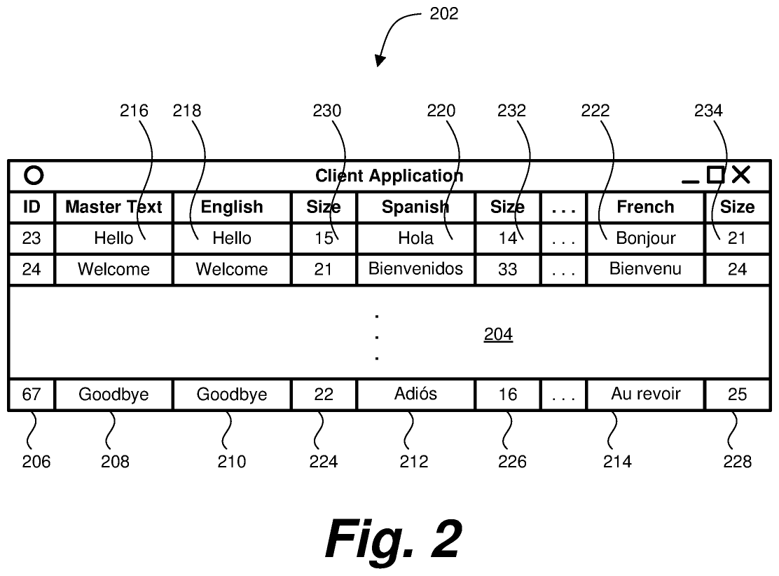

FIG. 2 shows an example of a client application 202 executing at the client. The client application 202 may be a spreadsheet, a browser, and/or a database management system, for example. The client application 202 includes a translation table 204 for storing display texts in different languages. In one implementation, the translation table 204 can be specifically adapted to store messages in several languages for a user interface in an automobile display.

The translation table 204 includes a record ID column 206 to identify each record or row in the table 204. In one implementation, the record ID is a numeric value, however, alpha-numeric identifiers may be used. In FIG. 2, three records are shown with record IDs of 23, 24 and 67.

The translation table 204 can include a master text column 208 containing a display text serving as the basis for text translations to other languages. The master text column 208 may contain words, phrases, and/or paragraphs of text. In one implementation, the client application 202 detects the language of the text entered in the master text column 208, e.g., using a suitable program or technique to detect a language of a text. For example, the client application 202 may use Google's Cloud Natural Language API or Microsoft's Text Analytics API to determine a text's language. Alternatively, a user may specify the default language of the master text in the client application 202.

The translation table 204 includes columns containing translations of the master display text into one or more respective languages, such as an English column 210, a Spanish column 212, and a French column 214. For example, in the row entry with the entry ID of 23, the master text cell 216 in the master text column 208 contains “Hello”, the English cell 218 in the English column 210 also contains “Hello”, the Spanish cell 220 in the Spanish column 212 contains “Hola”, and the French cell 222 in the French column 214 contains “Bonjour”. It is contemplated that additional or alternative language columns may be present in the translation table 204 depending on user need.

The language entries may be manually entered by the user or may be generated by the client application 202. For example, upon entering text in a master text cell, the client application may send a request to a translation service and fetch translations of the master text entry in various languages specified by the user. Once the translation texts are received by the client application 202, the cells corresponding to each language are automatically populated by the application 202. The user may override the generated translation by manually entering a different translation.

Each language column has a corresponding string size column to store the pixel length of the display text rendered on the intended display. For example, the English column 210 has a corresponding English string size column 224, the Spanish column 212 has a corresponding Spanish text size column 226, and so on. Values in string size columns are generated by the server.

In particular, the client application 202 includes instructions to send a client request over a computer network to an API endpoint at the server when a language cell is populated with an entry. The client request includes a string specification to enable the server to determine the pixel size of the display text. Once the pixel size is determined by the server, a response is transmitted by the server to client that includes the pixel size of the display text.

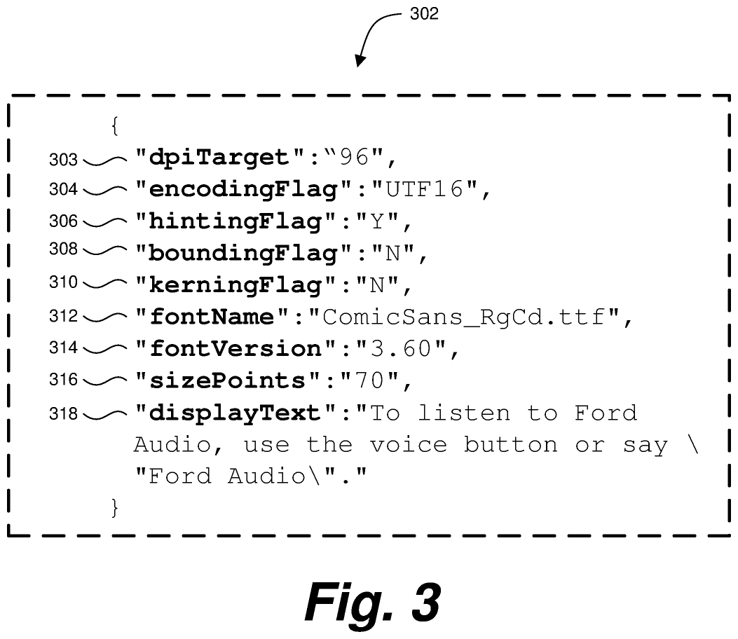

FIG. 3 shows an example string specification 302 encoded in JSON and enclosed in a body of a HTTP POST request method from the client. As discussed above, the string specification may be formatted in XML or some other suitable data schemas. In one configuration, the client application 202 includes a macro to assemble and send the string specification 302 to the server once a display text is entered in a language cell of the language table.

The string specification 302 can include a display dots per inch (DPI) value 303. This value indicates the display resolution that will eventually be used to show the display text. Typical values may be 72 or 96. An encoding flag 304 indicates whether the string is encoded in UTF8 for Windows® based systems or UTF16 for Linux® based systems. A hinting flag 306 is used to enable an internal font mechanism to better define glyphs at certain size points. A bounding flag 308 specifies measurement of the rendered text based on a surrounding box or a margin box in a given text. A kerning flag 310 indicates the space in between glyphs or characters. This flag is dependent on whether the display text is for Latin based languages or for non-Latin based languages. The font name value 312 specifies the font file name that should be used when measuring the display text length. The font version value 314 provides the working version of the font name. The font size value 316 indicates the size of the font to be rendered by the service in points. The display text 318 is the translation variant of a given master text, in a given language, that is going to be measured by the service. The string specification 302 can include other information not shown, such as a hash value to authenticate the client 106. A user such as an HMI designer could provide the necessary parameter information to the client application.

In one implementation, several translation variants of the master text may be specified in a single string specification 302. In such a case, the string specification 302 may be structured as an array of objects, with each object indicating a different set of parameters for the display text to be measured.

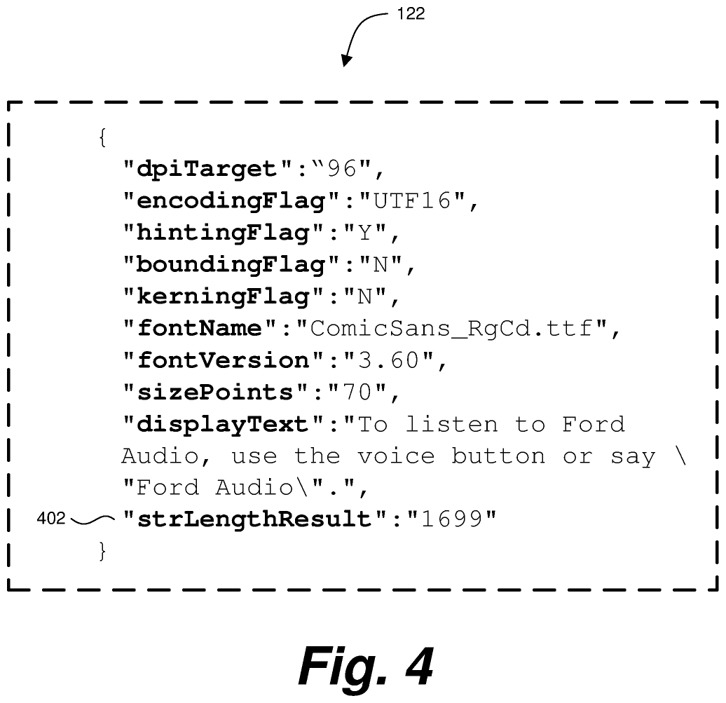

Upon receiving the client request, the server processes the request according to the parameters in the string specification 302. The server then sends a server response back to the client. FIG. 4 shows an example server response 402 when the server can successfully complete the client request and return a string measurement.

As shown, the server response 122 may be a JSON object. Other data representations could be used. The response 122 may include the parameters in the original client request, such as the font name, font version, font size, display text, DPI, encoding flag, kerning flag, hinting flag, display text, and so on. The server response additionally contains the string length 402 calculated by the server. The string size 402 indicates the pixel length of the display text based on values in the string specification. For example, the display text, “To listen to Ford Audio, use the voice button or say \“Ford Audio\”.”, has a calculated string size 402 of 1699 pixels. This is the calculated width in pixels of the text if it was to appear on a display specified by the string specification parameters.

Turning back to FIG. 2, once the server response is received by the client, the client application 202 extracts the string size from the server response, matching the string size value to the correct translation variant text. The string size is then entered into the cell corresponding to the translation variant text. For example, the English variant text size in cell 230 is populated with a value of 15 pixels for corresponding English translation variant text 218. This value was extracted from the server response and entered into cell 230 by the client application 202. Similarly, cell 232 is populated with a value of 14 for corresponding Spanish translation variant text 220 and cell 234 is populated with a value of 21 for corresponding French translation variant text 222.

In one implementation, the client application 202 parses the JSON server response and collects the string size. The client application 202 determines a margin field by subtracting the string size from the available width of the display screen. If the margin field is less than zero, the translation will not fit on the screen and the translator needs to provide a shorter translation, replace some equivalent words, and/or use abbreviations in the translation. After a new translation is entered, a new client request is issued, and the process is repeated.

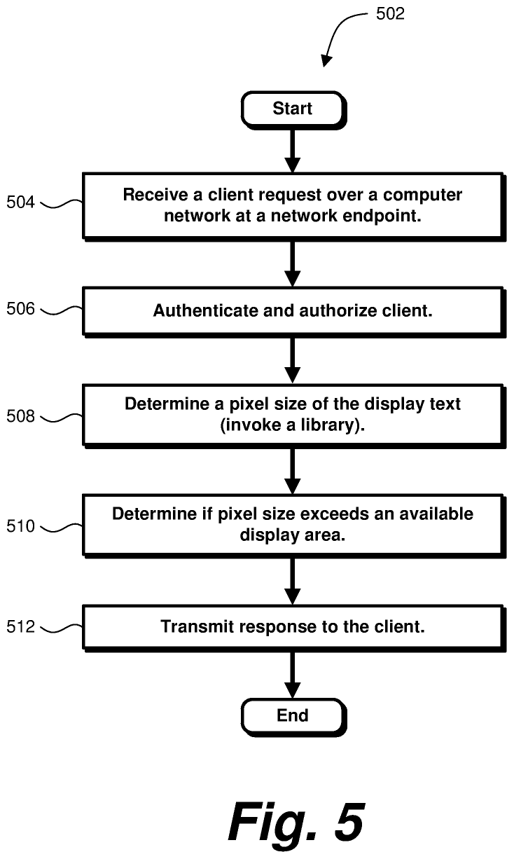

FIG. 5 shows one example of a method 502 for distributed string length computation. The method includes receiving operation 504. During this operation, a client request is received over a computer network at a network endpoint. As discussed, the client request 120 may include a string specification. In one implementation, the string specification can contain a display text, a font identifier, a font size, a display resolution, and an available display screen area at a vehicle display. After receiving operation 504, control passes to authenticating operation 506.

At authenticating operation 506, the client 106 is authenticated by the server 104. This operation may include comparing a hash value received from the client 106 to a stored hash value at the server. The authenticating operation 506 may include an authorization operation to determining if the client 106 is authorized to use the services of the server.

The server 104 may additionally maintain a transaction log for analytics purposes. Information in the transaction log can be used to optimize server performance, compile user statistics, and collect insights to HMI design trends. After authenticating operation 506, control passes to determining operation 508.

At determining operation 508, the pixel size of the display text is determined based on the string specification. As mentioned above, the server 104 may query a database and receive a font list based on a font name and version in the client request. The font list can include directories with different versions of the specified font.

The determining operation 508 may include invoking a library configured to return the pixel size of the display text and receiving the pixel size of the display text from the library. The server call to the library can include the display text, a font directory, and various parameters needed to calculate the display text's pixel width. In one implementation, the library is a rendering engine at the server 104, such as the FreeType library developed by The FreeType Project, http://freetype.org/, the Java FontMetrics library, or the iType® DLL developed by Monotype Imaging Inc., of Woburn, Massachusetts, USA, https://www.monotype.com/. The library returns a data object to the server. The server then selects the appropriate values from the data object to determine the string length in pixels based on the display text and the parameters. After determining operation 508, control passes to determining operation 510.

At determining operation 510, the server 104 determines whether the pixel size exceeds an available display screen area. In one implementation, the display screen area is at a vehicle display. After determining operation 510, control passes to transmitting operation 512.

At transmitting operation 512, the server transmits a server response to the client over the computer network. The server response includes the pixel size of the display text. If the pixel size exceeds the available display area at the vehicle display, the server response 122 may include an overflow indication or an error message.

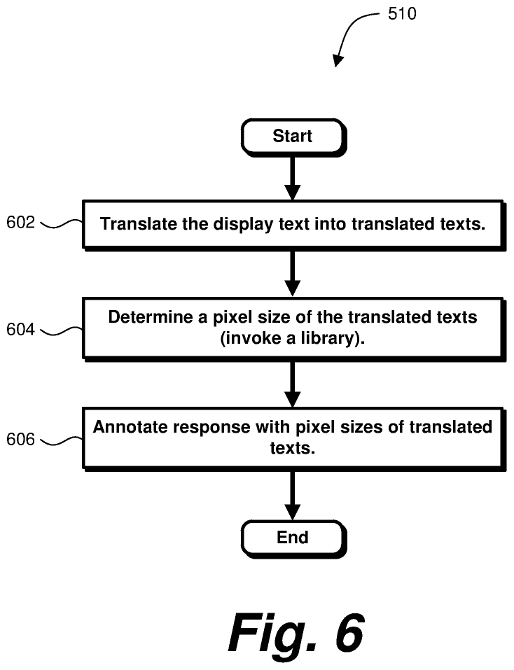

FIG. 6 shows an implementation of the determining operation 510. The determining operation 510 includes a translating operation 602 configured to translate the display text into a plurality of translated texts. Each of the translated texts is translated into a different language than the display text. After translating operation 602, control passes to determining operation 604.

At determining operation 604, the pixel size of each of the plurality of translated texts is determined based on the string specification. As discussed above, this operation may include calling a library by the service. After determining operation 604, control passes to annotating operation 606.

At annotating operation 606, the server response 122 to the client 106 is annotated with the pixel sizes of the translated texts. For example, the server response may include a JSON array object with entries of the array representing different text translations and pixel sizes. Array entries may include an indication of whether the pixel size exceeds an available display area.

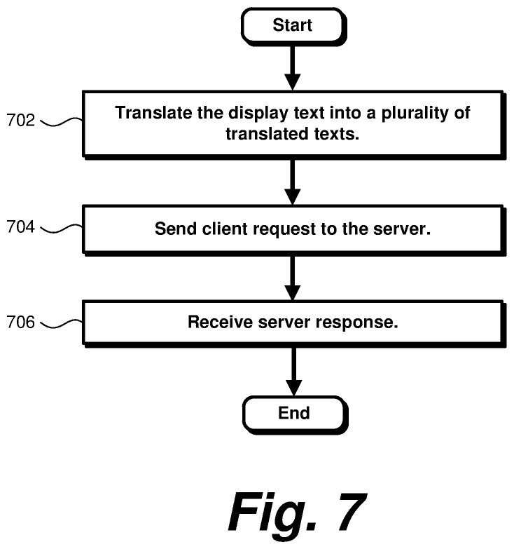

FIG. 7 shows an implementation of method operations performed by a client 106. The method includes translating operation 702. During this operation, the client 106 translates the display text into a plurality of translated texts. Each of the translated texts is translated in a different language than the display text.

In one implementation, the client application 202 calls a translation service, passing to the translation service a master text entry in the translation table. The translation service translates the master text entry to various languages specified by the client 106 and returns the resulting translations to the client 106. The client application 202 may automatically populate the different language cells in the translation table by matching the translated text to the appropriate language column in the table. After translating operation 702, control passes to sending operation 704.

At sending operation 704, the client 106 sends the client request 120 to the server. In one implementation, the client 106 may query a display database to determine an available display area, screen resolution and other parameters for the HMI screen. The client request 120 may be in JSON format and may include one or several display texts that require size calculations. The client request 120 may include user authentication data to permit server access. After sending operation 704, control passes to receiving operation 706.

At receiving operation 706, the client 106 waits for a response back from the server 104. Once the server response 122 is received, the client application 202 extracts the size of the display text and displays the value in the corresponding translation table cell. The client application may also check for an overflow error. If an overflow error is indicated in the server response, the client application indicates to the user that the display text's calculated width exceeds the display area. It is thereby possible to reduce the amount of configuration needed to determine the pixel width of display text, such as installing local font files and library components, at the client computer.

The descriptions of the various examples and implementations have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for distributing string length computation, the system comprising:
a server computer processor coupled to a computer network; and
a server memory, the server memory storing server instructions executable by the server computer processor to:
receive a client request over the computer network at a server network endpoint, the client request including a string specification, the string specification including one or more of a display text, a font identifier, a font size, and a display resolution;
determine a pixel size of the display text based on the string specification; and
transmit a server response over the computer network, the server response including the pixel size of the display text.

2. The system of claim 1,
wherein the server instructions further include instructions to determine whether the pixel size exceeds an available display area at a vehicle display; and
wherein the server response includes an overflow indication when the pixel size exceeds the available display area at the vehicle display.

3. The system of claim 2, wherein the string specification includes the available display area.

4. The system of claim 1, wherein the server instructions further include instructions to:
query a library configured to return the pixel size of the display text; and
receive the pixel size of the display text from the library.

5. The system of claim 1, wherein the server instructions further include instructions to:
authenticate a client that transmitted the client request; and
determine that the client is authorized to use services of the server computer processor.

6. The system of claim 1,
wherein the server instructions further include instructions to:
translate the display text into a plurality of translated texts, each of the plurality of translated texts having a different language than the display text; and
determine the pixel size of each of the plurality of translated texts based on the string specification; and
wherein the server response includes the pixel size of each of the plurality of translated texts.

7. The system of claim 1, further comprising:
a client computer processor coupled to the computer network; and
a client memory, the client memory storing client instructions executable by the client computer processor to send the client request over the computer network from an application executing at the client, the application including a first cell displaying the display text and a second cell configured to display the pixel size transmitted by the server computer processor.

8. The system of claim 1, further comprising:
a client computer processor coupled to the computer network; and
a client memory, the client memory storing client instructions executable by the client computer processor to
translate the display text into a plurality of translated texts, each of the plurality of translated texts having a different language than the display text;
wherein the server instructions further include instructions to determine the pixel size of each of the plurality of translated texts based on the string specification, wherein the text specification includes the plurality of translated texts; and
wherein the server response includes the pixel size of each of the plurality of translated texts.

9. A method for distributed string length computation, the method comprising:
receiving by a server a client request over a computer network at a network endpoint, the client request including a string specification, the string specification including one or more of a display text, a font identifier, a font size, and a display resolution;
determining by the server a pixel size of the display text based on the string specification; and
transmitting by the server a server response over the computer network, the server response including the pixel size of the display text.

10. The method of claim 9, further comprising:
determining whether the pixel size exceeds an available display area at a vehicle display,
wherein the string specification includes the available display area; and
wherein the server response includes an overflow indication when the pixel size exceeds the available display area at the vehicle display.

11. The method of claim 10, wherein the string specification includes the available display area.

12. The method of claim 9, further comprising:
invoking a library configured to return the pixel size of the display text; and
receiving the pixel size of the display text from the library.

13. The method of claim 9, further comprising:
authenticating by the server a client that originated the client request; and
determining by the server if the client is authorized to use services of the server.

14. The method of claim 9, further comprising:
translating by the server the display text into a plurality of translated texts, each of the plurality of translated texts is in a different language than the display text; and
determining by the server the pixel size of each of the plurality of translated texts based on the string specification; and
wherein the server response includes the pixel size of each of the plurality of translated texts.

15. The method of claim 9, further comprising sending by a client the client request over the computer network from an application executing at the client, the application including a first cell displaying the display text and a second cell configured to display the pixel size transmitted by the server.

16. The method of claim 9, further comprising:
translating by a client the display text into a plurality of translated texts, each of the plurality of translated texts is in a different language than the display text;
determining by the server the pixel size of each of the plurality of translated texts based on the string specification, wherein the text specification includes the plurality of translated texts; and
wherein the server response includes the pixel size of each of the plurality of translated texts.

17. A computer program product for distributing string length computation, the computer program product comprising:
a non-transitory computer readable storage medium having computer readable program code embodied therewith, the computer readable program code configured to:
receive a client request over a computer network at a network endpoint, the client request including a string specification, the string specification including one or more of a display text, a font identifier, a font size, and a display resolution;
determine a pixel size of the display text based on the string specification; and
transmit a server response over the computer network, the server response including the pixel size of the display text.

18. The computer program product of claim 17, further comprising:
wherein the computer readable program code is further configured to determine whether the pixel size exceeds an available display area at a vehicle display; and
wherein the server response includes an overflow indication when the pixel size exceeds the available display area at the vehicle display.

19. The computer program product of claim 18, wherein the string specification includes the available display area.

20. The computer program product of claim 17, wherein the computer readable program code is further configured to:
query a library configured to return the pixel size of the display text; and
receive the pixel size of the display text from the library.
